(19) United States
(12) Patent Application Publication
(10) Pub. No.: US 2015/0316120 A1
(43) Pub. Date: Nov. 5, 2015

(54) BEARING

(71) Applicant: CARL FREUDENBERG KG, Weinheim (DE)

(72) Inventor: Detlef Cordts, Wandlitz (DE)

(21) Appl. No.: 14/649,266

(22) PCT Filed: Oct. 30, 2013
(86) PCT No.: PCT/EP2013/003273

§ 371 Date: Jun. 3, 2015

(30) Foreign Application Priority Data
Dec. 4, 2012 (DE) 10 2012 023 616.6

(51) Int. Cl. F16F 13/08; F16F 1/36; F16F 13/00

(52) U.S. Cl. CPC F16F 13/08; F16F 13/002; F16F 1/36; F16F 2238/04

(57) ABSTRACT

A bearing with a first cover plate and a second cover plate, an elastomer layer being arranged between the first cover plate and the second cover plate. The bearing can exhibit a long service life after an inexpensive manufacturing process. The bearing may have reinforcing fibers paired with the elastomer layer.

### CROSS-REFERENCE TO RELATED APPLICATIONS

This application is a U.S. national stage application under 35 U.S.C. §371 of International Application No. PCT/EP2013/003273, filed on Oct. 30, 2013, and claims benefit to German Patent Application No. DE 10 2012 023 616.6, filed on Dec. 4, 2012. The International Application was published in German on Jun. 14, 2014, as WO 2014/086447 A1 under PCT Article 21(2).

### FIELD

The invention relates to a bearing.

### BACKGROUND

It is already known from the prior art to use endless fibers in the form of rovings as reinforcement in elastomers. The endless fibers serve, for example, as strength supports in V-belts or as woven fabrics in hoses, tires and pneumatic spring bellows.

Moreover, bearings which are configured as multilayered springs are known from the prior art. Said multilayered springs have rubber/metal constructions. EP 2 360 388 A discloses multilayered springs of the above mentioned type.

Structural bearings are known from the literature “FASERVERSTÄRKTE ELASTOMERLAGER—Konzeption and Bemessung” [FIBER-REINFORCED ELASTOMERIC BEARINGS—design and dimensions”]; Ulrich Gerhaher; Vienna, August 2010.

The previously known multilayered constructions of the bearings are cost-intensive, since a multiplicity of metal sheets have to be produced. Furthermore, the bearings are cost-intensive to process, since the metal sheets have to be cleaned and coated. Furthermore, the metal sheets have to be inserted into dies.

The production of bearings of this type which have metal sheets and elastomer layers is not simple to manage in terms of process technology. Bending of the metal sheets in the dies can occur during the injection of the elastomer.

In particular, relatively expensive dies have to be split in order to demold the bearings. Furthermore, what are known as collapsing cores possibly also have to be provided in order to demold a central bore.

The loading of the elastomers in the known bearings can be very inhomogeneous. A pronounced concentration of the extension can occur at the outer edge of an elastomer. The rise of the spring constants under load, namely the progressivity of a bearing, is limited by the permissible extensions in the elastomer. The damping is limited by the loss angles which can be achieved in the typically used elastomers.

### SUMMARY

An aspect of the invention provides a bearing, comprising: a first cover plate; a second cover plate; and an elastomer layer, arranged between the first cover plate and the second cover plate, wherein the elastomer layer includes reinforcing threads.

### BRIEF DESCRIPTION OF THE DRAWING

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a bearing which is filled with gas and liquid;

FIG. 2 shows a bearing which is filled with gas and liquid, a nozzle being arranged between the gas space and the liquid space;

FIG. 3 shows an arrangement, in which a bearing is connected to a liquid space with an external hydraulic accumulator; and

FIG. 4 shows a further bearing which is filled with gas and liquid under pressure.

### DETAILED DESCRIPTION

An aspect of the invention comprises configuring and developing a bearing of the type mentioned at the outset, in such a way that said bearing exhibits a long service life after inexpensive production.

It has first of all been recognized according to an aspect of the invention that the known bearings are relatively expensive to produce. In addition, it has been recognized that a deformation prevention of the elastomer layer can be produced not in a concentrated manner at individual points by way of metal sheets, but rather in a “spread” manner by way of reinforcing threads on the entire surface.

The deformation of the elastomer layer is substantially less pronounced, with the result that no local extension concentrations occur in the elastomer at metal sheet ends. The procurement and the processing of intermediate metal sheets is completely dispensed with. The entire overall height between the two cover plates can be utilized for lower shear stiffness. The thicknesses of the intermediate metal sheets reduce this utilizable height in the known bearings.

As a result of the use of reinforcing threads, the geometry of a die for production can be selected much more simply and less expensively. For example, a cylindrical shape is possible and no splitting is necessary.

To this extent, a bearing is configured in such a way that it exhibits a long service life after inexpensive production.

As a consequence, an aspect of the invention which was mentioned at the outset is achieved.

The bearing might exhibit two stiffness values in two directions which are orthogonal with respect to one another, the stiffness values differing by a factor of up to 15,000. The lower limit of this numerical range is the factor 0.2 which is representative for no difference. The preferably very different stiffnesses in two orthogonal directions can be achieved by the use of reinforcing threads instead of metal sheets and by abandoning the prior art which is influenced by thinking traditionally in terms of “form factors” for setting stiffness ratios in rubber springs and rubber bearings.

The reinforcing threads might enclose or surround the elastomer layer or might be embedded into a radially outer region of the elastomer layer. The compressive stiffness of a bearing is determined essentially by the modulus of elasticity and the quantity of reinforcing threads on the circumference of the elastomer layer. By way of the selection of the material and the quantity of reinforcing threads, very different stiffnesses with one geometry and also different utilizations of the strength of the reinforcing threads can be set.

For example, nylon where E=1500-3000 N/mm², aramid where E=53,000 N/mm² or polyethylene where E=85,000 N/mm² might be selected as material. Furthermore, a metal, in particular steel, might be used as material, since metals have high moduli of elasticity.

The reinforcing threads might run at least partially in planes which are inclined with respect to the longitudinal axis of the bearing at an angle which differs from 90°. The shear stiffness of the bearing can be increased by way of inclined reinforcing threads. New areas of use are thus opened up which require a defined shear stiffness of the bearing. The bearing can be used, for example, as a primary spring in rail vehicles.

The reinforcing threads might form a roving or be arranged in a roving. By way of the orientation of a roving, transverse stiffnesses of the bearing can be set in a targeted manner. By way of rovings which are preferably not oriented exactly in the circumferential direction, the transverse stiffness can be set and the bearing can be used for primary suspension systems in rail vehicles. A roving can be produced, for example, by reinforcing threads which lie next to one another being rolled together with rubber.

Furthermore, it is conceivable to use tailored rovings, reinforcing threads being inserted in a rubber. The reinforcing threads might run around the outer circumferential face of the elastomer layer two or more times, with or without overlapping. This prevents reinforcing threads abutting one another and prevents the elastomer of the elastomer layer bulging out between the reinforcing threads.

A roving can consist of a plurality of layers of what are known as reinforcing thread rovings which are arranged in parallel. The reinforcing thread orientation of the individual layers can differ. The alignment of the reinforcing thread orientation can be specified by way of an angle with respect to the production direction. Here, the production direction is the 0° position.

There are two-layer (what are known as biaxial) rovings, in which the orientation of the reinforcing threads is, for example, 0° and 90°. There are also orientations of +45°/−45°.

Furthermore, there are multiple-layer (what are known as multiaxial) rovings, with a layer orientation of 90°, −45°, 0° and +45°, there being a four-layer formation here.

The layers are usually first of all not connected to one another. For improved processability, they can be knitted to one another. Fibers which are laid down rectilinearly and are not crimped can absorb very high loads. In woven fabrics, however, fibers are crimped in contrast to rovings.

A roving which has already been impregnated with elastomer can be processed rapidly, but has the disadvantage that the reinforcing threads or reinforcing thread rovings have only a finite length. It is therefore necessary to wrap the elastomer layer around at least twice in a roving of this type.

The reinforcing threads might be configured as endless threads or endless fibers. As a result, the reinforcing threads can be wound onto the elastomer layer without problems. An endless thread or an endless fiber can be wound around the outer circumferential face of the elastomer layer, for example, 100 times. The reinforcing threads preferably bear tightly against one another, in particular with an inclined arrangement. It is also conceivable, however, to maintain a reinforcing thread spacing between the reinforcing threads. It has to be ensured in every case, however, that no elastomer bulges out between the reinforcing threads. Against this background, it is conceivable to lay a nonwoven, preferably a thin nonwoven, between the reinforcing threads and the elastomer.

The elastomer layer might have a recess in its interior, which recess is filled with a gas and/or a liquid. Expensive elastomer is saved by way of a fluid filling, preferably in the center of the bearing. A vulcanization time is considerably shortened because the block-like elastomer layer can also be heated from the inside. A very progressive characteristic can be designed within broad limits by way of a gas filling as an alternative or in addition to a liquid.

A gas space and a liquid space which can be flow-connected to one another by a nozzle and/or throttle might be configured in the recess. As a result of a separation of one or more gas and liquid spaces by a nozzle and/or throttle point, the bearing can additionally assume damper tasks in the vertical direction.

The bearing which is described here can in principle be used instead of all rubber/metal components with a great stiffness difference in two directions.

These include, in particular, multilayered springs with many sheet metal layers, as are used, for example, in secondary spring systems of rail vehicles. The bearing can likewise be used as a structural bearing for supporting buildings and bridges. The bearing can be used as or in primary springs or secondary springs for rail vehicles, as a structural bearing or as a bridge bearing.

From analytical, simplified observations, the following applies to a bearing which is configured as a solid spring:

$$\frac{{C}_{D}}{{C}_{S}} = \frac{d}{D} \cdot \frac{{E}_{F}}{G}$$

where C_{D}=compressive stiffness, C_{S}=shear stiffness, d=mean thickness of the reinforcing thread shell, D=diameter of the spring, E_{F}=tensile modulus of the reinforcing thread and G=shear modulus of the elastomer.

From analytical, simplified observations, the following applies to a bearing which is configured as a hollow spring which is filled with fluid:

$$\frac{{C}_{D}}{{C}_{S}} = \frac{d \cdot D}{( {D}^{2} - {D}_{i}^{2} )} \cdot \frac{{E}_{F}}{G}$$

where Dᵢ=internal diameter (bore) of the hollow spring.

The realistic stiffness ratio

$$\frac{{C}_{D}}{{C}_{S}}$$

ranges from

$$\frac{{C}_{D}}{{C}_{S}} = 0.2$$

for a solid spring without bore in the case of a thin single reinforcing thread layer where d/D=0.00025, E_{F}=1000 N/mm² and G=1.5 N/mm², as far as

$$\frac{{C}_{D}}{{C}_{S}} = 15 , 000$$

for a spring which is filled with fluid in the case of a thick reinforcing thread layer where d/D=0.033, Di/D=0.75, E_{F}=210,000 N/mm² and G=1 N/mm².

The lowest shear stiffnesses are achieved with a reinforcing thread angle of 0°, which corresponds to a purely tangential winding.

The transverse stiffness of the bearing can be set in a targeted manner via an inclination of the reinforcing thread by up to 45°. Different transverse stiffnesses are preferably achieved with only small changes in the compressive stiffness in the region from 0° to 15°.

The reinforcing threads are typically wound tightly with small reinforcing thread spacings, or rovings with small reinforcing thread spacings are used.

The reinforcing thread spacing preferably has a value which lies in the range from smaller than the reinforcing thread diameter to four times the value of the reinforcing thread diameter.

In the case of reinforcing thread spacings which are greater than four times the reinforcing thread diameter, the risk of possibly unstable bulging of the elastomer between the reinforcing threads increases depending on the vertical maximum loading of the bearing.

In the case of bearings with reinforcing threads which are inclined in a crosswise manner, the reinforcing thread spacing can be selected to be greater, preferably up to six times the reinforcing thread diameter in the case of an inclination of 15° and up to ten times the reinforcing thread diameter in the case of an inclination of 45°.

In order to counter bulging of the elastomer in the case of design-induced relatively great reinforcing thread spacings, namely predominantly in the case of particularly soft springs, a nonwoven made preferably from the same material or a material with a lower modulus of elasticity can be laid under the reinforcing thread layer, which nonwoven prevents bulging even in the case of relatively great reinforcing thread spacings. Unbound nonwovens with a thickness from 0.1 to 0.5 mm are typically used.

Plastic fibers are preferably used as reinforcing threads. Aramid fibers or metal fibers are preferably used for fire prevention applications.

Carbon fibers and metal fibers, preferably steel fibers, can also be used to produce very high stiffness ratios.

Steel fibers are preferably used in order to bring about low settling.

The bearing which is described here can be used in construction machines and agricultural machines. It can be used as an engine mounting, since it exhibits a low weight and can be of corrosion-resistant configuration.

The bearing can be used as a structural bearing, since it has a simple construction and can be produced inexpensively. Steel fibers can advantageously be used, in order to bring about low settling.

It can be used to mount vibrating rollers, since high stiffness ratios can be set and inexpensive production is possible.

In wind power applications, the use of the bearing as motor/gear mounting is conceivable, since a torque support, a low weight with high stiffnesses and a corrosion-resistant embodiment, in particular with aramid fibers or steel fibers as a covering for fire prevention, are possible.

The bearing can be used as an engine mounting for large engines in marine applications or in heat and power cogeneration plants. Torque supports, low weight and a corrosion-resistant embodiment, in particular with aramid fibers or steel fibers as a covering for fire prevention, can advantageously be realized.

In industry, the bearing can be used to mount compressors, for pipe mounting with play compensation and for compensating for thermal expansions. The bearing exhibits high stiffness ratios and is inexpensive.

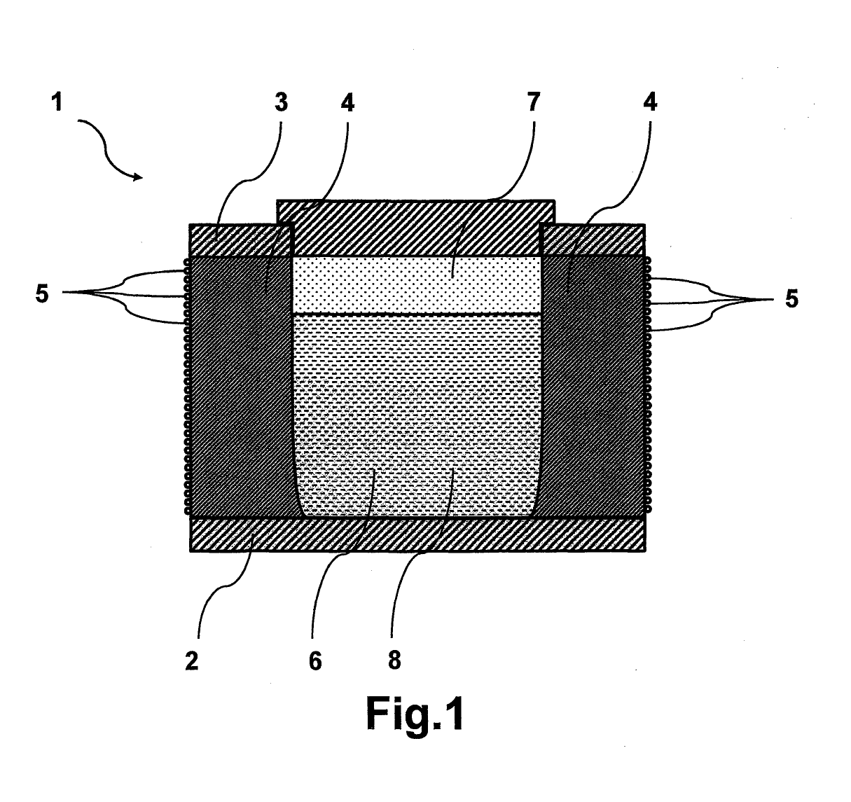

FIG. 1 shows a bearing 1, comprising a first cover plate 2 and a second cover plate 3, an elastomer layer 4 being arranged between the first cover plate 2 and the second cover plate 3. The elastomer layer 4 is assigned reinforcing threads 5. The bearing 1 exhibits two stiffness values in two directions which are orthogonal with respect to one another, the stiffness values differing by a factor of up to 15,000.

The reinforcing threads 5 enclose and surround the elastomer layer 4. The reinforcing threads 5 run on the outer circumferential face of the elastomer layer 4, the latter being received in a sandwich-like manner between the cover plates 2, 3. To this extent, the reinforcing threads 5 are not part of the elastomer layer 4, but rather are produced from a different material than the elastomer layer 4.

The elastomer layer 4 has a recess 6 in its interior, which recess 6 is filled with a gas 7 and a liquid 8.

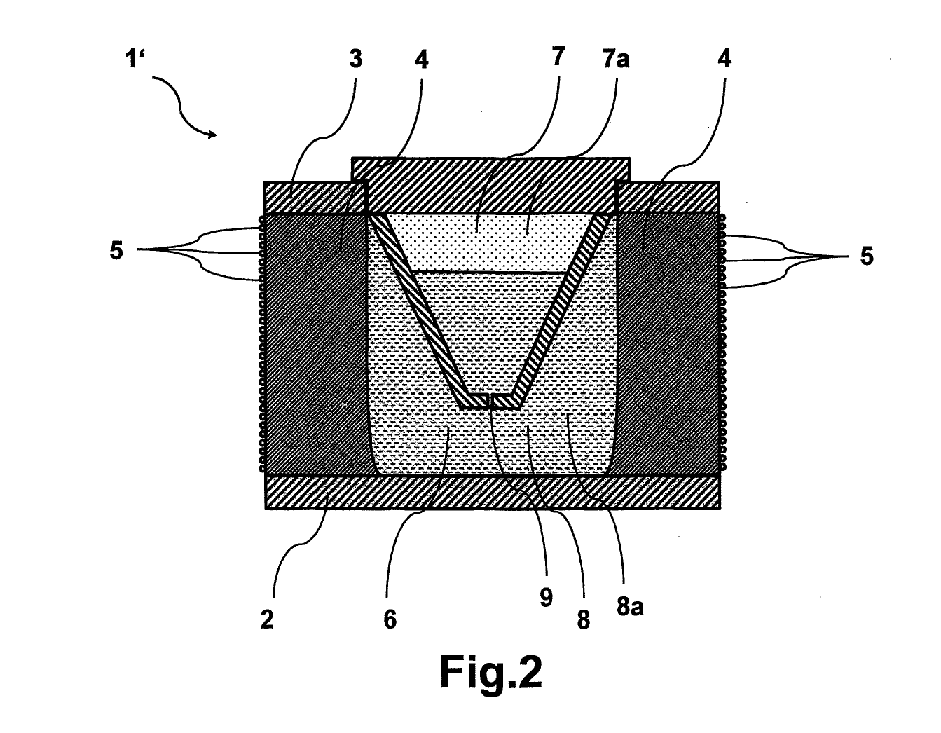

FIG. 2 shows a bearing 1′, in which a gas space 7a and a liquid space 8a which can be flow-connected to one another by a nozzle 9 are configured in the recess 6.

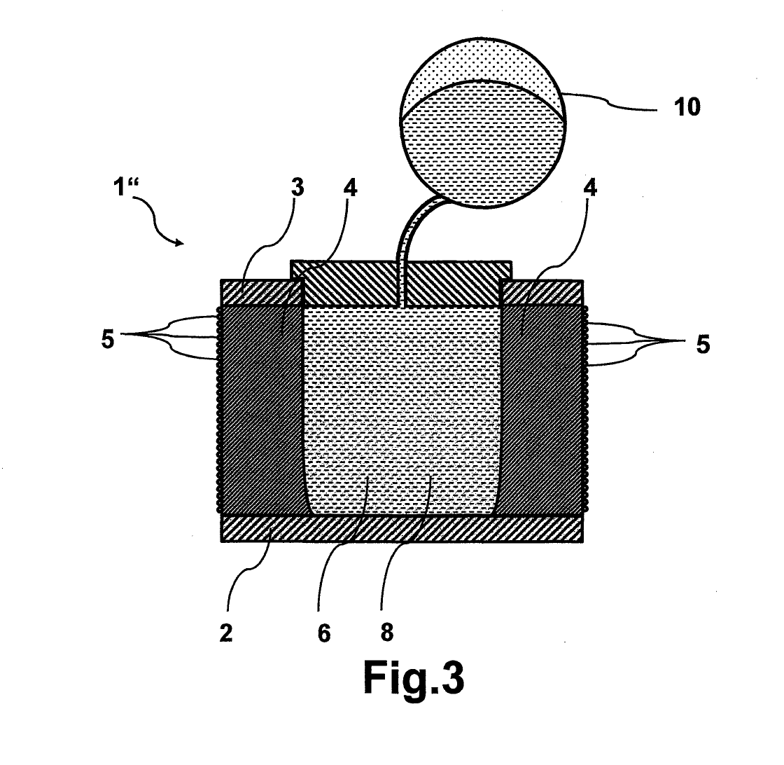

FIG. 3 shows an arrangement with an external hydraulic accumulator 10 and a bearing 1″, the recess 6 of which is filled with a liquid 8, the recess 6 being flow-connected to the external hydraulic accumulator 10.

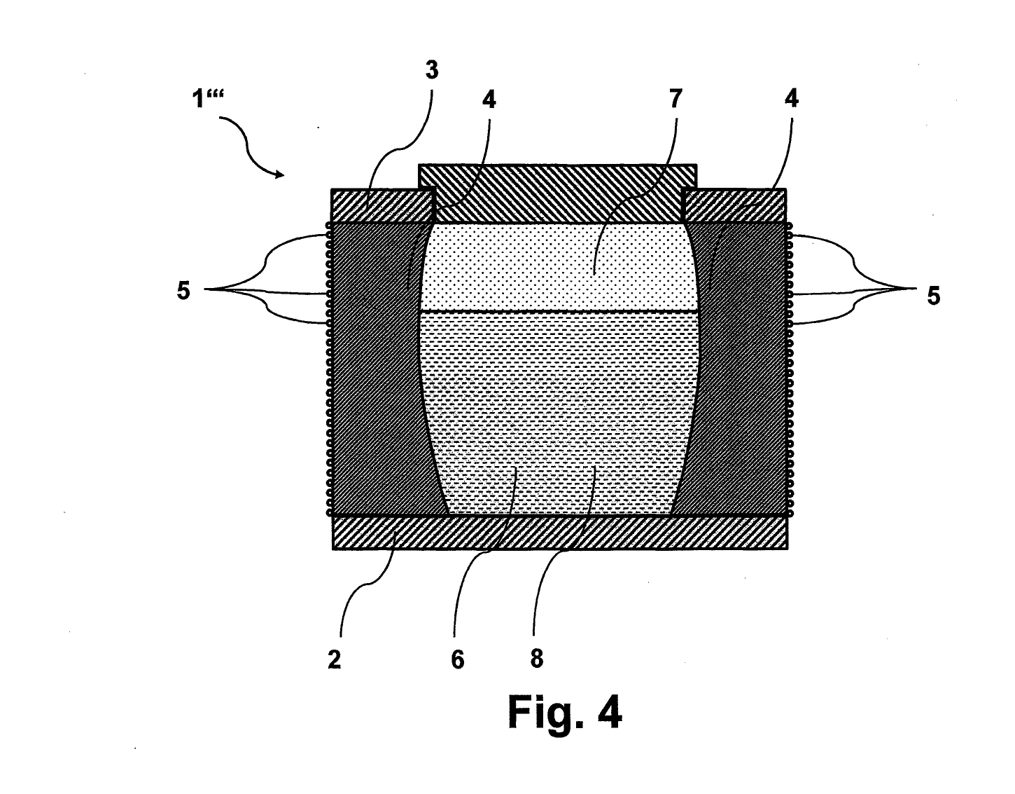

FIG. 4 illustrates a bearing 1′″ under internal pressure. The internal pressure was set during production. This provides a further possibility of changing the characteristics of the bearing 1′″.

The bearing 1, 1′, 1″, 1′″ which is shown in FIGS. 1 to 4 can replace a multilayered spring, in which a multiplicity of metal sheets and elastomer layers are usually arranged between two cover plates.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A bearing, comprising:
a first cover plate;
a second cover plate; and
an elastomer layer, arranged between the first cover plate and the second cover plate,
wherein the elastomer layer includes reinforcing threads.

2. The bearing of claim 1, having two stiffness values in two directions which are orthogonal with respect to one another, the stiffness values differing by a factor of up to 15,000.

3. The bearing of claim 1, wherein the reinforcing threads enclose the elastomer layer (4).

4. The bearing of claim 1, wherein the reinforcing threads run at least partially in planes which are inclined with respect to a longitudinal axis of the bearing at an angle which differs from 90°.

5. The bearing of claim 1 wherein the reinforcing threads form a roving.

6. The bearing of claim 1 wherein the reinforcing threads are configured as endless threads.

7. The bearing of claim 1 wherein the elastomer layer includes a recess in an interior of the elastomer layer,
wherein the recess is filled with a gas, a liquid, or a mixture of two or more of any of these.

8. The bearing of claim 7, wherein the recess comprises a gas space and a liquid space,
wherein the gas space and the liquid space are configured to flow-connectable to one another by a nozzle, a throttle, or a nozzle and a throttle.

9. A spring, comprising the bearing of claim 1.

10. The bearing of claim 1, wherein the reinforcing threads surround the elastomer layer.

11. The bearing of claim 1, wherein the reinforcing threads are embedded into a radially outer region of the elastomer layer.

12. The bearing of claim 1, wherein the reinforcing threads are arranged in a roving.

13. The bearing of claim 1, wherein the reinforcing threads are configured as endless fibers.

14. The bearing of claim 1, wherein the elastomer layer includes a recess in an interior of the elastomer layer,
wherein the recess comprises a gas, a liquid, or a mixture of two or more of any of these.

15. The bearing of claim 14, wherein the recess comprises a gas.

16. The bearing of claim 14, wherein the recess comprises a liquid.

17. The bearing of claim 14, wherein the recess comprises a gas and a liquid.

18. The bearing of claim 8, wherein the gas space and the liquid space are flow-connected to one another by a nozzle, a throttle, or a nozzle and a throttle.

19. The bearing of claim 8, wherein the gas space and the liquid space are flow-connected to one another by the nozzle.

20. The bearing of claim 8, wherein the gas space and the liquid space are flow-connected to one another by the throttle.
